(19) United States
(12) Patent Application Publication
(10) Pub. No.: US 2018/0321502 A1
(43) Pub. Date: Nov. 8, 2018

(54) ASSEMBLING APPARATUS AND METHOD THEREOF

(71) Applicant: NEW SMART TECHNOLOGY CO.,LTD.

(72) Inventor: Sentry Lee, Taipei City (TW)

(21) Appl. No.: 15/968,742

(22) Filed: May 1, 2018

Related U.S. Application Data
(60) Provisional application No. 62/500,469, filed on May 2, 2017.
(60) Provisional application No. 62/500,476, filed on May 2, 2017.
(60) Provisional application No. 62/500,481, filed on May 2, 2017.

(51) Int. Cl. G02B 27/62

(52) U.S. Cl. CPC G02B 27/62; G02B 7/021

(57) ABSTRACT

An assembling apparatus for assembling an optical module has a barrel holder driven to move upwardly and downwardly for assembling lens into a barrel. Different stages with different forces are applied to the barrel holder. In addition, test images may be collected to further adjust a barrel and a holder, which may be components of a mobile phone or others with a camera.

### FIELD OF INVENTION

The present invention is related an assembling apparatus and method thereof and more particularly related to an assembling apparatus and method for assembling optical components.

### BACKGROUND

When cameras appear on various electronic devices, there is stronger need for precisely assembling optical components of a camera. Usually, a barrel is used for holding a plurality of lenses. The lens barrel is mounted on a holder and an image sensor is also provided for receiving images through the lens barrel. It is important to assemble multiple lens into the barrel and also important to precisely assemble the lens barrel with a corresponding holder.

### SUMMARY OF THE INVENTION

According to an embodiment of the present invention, an assembling apparatus is designed for assembling an optical module. The optical module includes a barrel holding multiple lenses. To limit unnecessary random light, some light shielding components like SOMA may be put between lenses in a barrel.

The assembling apparatus may include a lens collector and a barrel holder.

The lens collector is designed for getting a lens from a tray plate to be assembled to the barrel. When a barrel needs to mount multiple barrels, there may be multiple lens collectors in one assembling apparatus. Furthermore, there may be two or more sets of such design for assembling two or more barrels in one time.

The lens collector moves the lens above the barrel holder. Then, the barrel holder is designed with a positioning driver for moving the barrel upwardly to engage with the lens with a controlled strength and position driven by the positioning driver.

In some embodiments, when the barrel holder is controlled to move upwardly to engage with the lens, there are an introducing stage and a major assembling stage occurred in sequence. In the introducing stage, a first force is applied to the barrel holder by the positioning driver. In the major assembling stage, a second force is applied to the barrel holder by the positioning driver. The first force is smaller than the second force. For example, in the introducing stage, the force may be 300 g/cm2 and in the major assembling stage, the force may be 2000 g/cm2 to 3000 g/cm2.

To provide precise controlling effect, the positioning driver may include a servo motor with a corresponding driving mechanism, like a series of linkage lever with rolling balls, for driving the barrel holder to move upwardly or downwardly with a controlled speed and force. With optical measuring device, such positioning driver may be controlled within precision level of 0.01 mm.

In some cases when the lens collector is not aligned perfectly with the barrel holder. For example, the surface of the lens held by the lens collector is not parallel to the surface of the barrel. In such case, when the lens is inserted into the barrel, there may be a tilt angle between the lens and the barrel. To make the assembling more reliable as expected, the barrel holder may be moved downwardly for a distance, rotate an angle and then engage the lens again. By changing the barrel with an angle and then applying force thereon, the lens may be assembled more reliably. Such process may be adopted for more than one times. In other words, the barrel holder may be rotated with a plurality of angles for engaging with the barrel with the plurality of angles sequentially. To prevent damage, the barrel holder may be moving downwardly before changing another angle to engage with the lens again.

As mentioned above, there may be a measuring device on the barrel holder to measure the moving distance of the barrel holder. When multiple lens and other components are stacked one after another into a barrel, each operation may correspond to a measured distance. By calculating multiple measured distances, the relative distance of lens may be obtained. Such result may be fed back to the controlling of the barrel holder. In other words, if there are any unwanted error, such error may be adjusted if available, e.g. by pressing additional force to press the barrel or lens.

In other cases, the lens collector may have an adjusting device for adjusting the relative angle with respect to the barrel holder. For example, several adjusting screws for adjusting angle of the lens collector may be applied. An operator may adjust these adjusting screws to ensure the lens collector aligns better with respect to the barrel holder.

In some cases, a collimator may be used firstly to align with the barrel holder and then the aligned collimator is further used for adjusting the adjusting device of the lens collector for aligning the relative angle between the lens collector and the barrel holder. Such collimator has a light source to emit light to move within the collimator and the light then moves to a corresponding optical component, e.g. a mirror, before being directed to a sensor. If the collimator is perfectly parallel to the barrel holder that is placed with the optical component, the sensor receives the transmitted light. Otherwise, the collimator is adjusted for an angle until the collimator aligns with the barrel holder. After the collimator aligns with the barrel holder, the lens collector is adjusted to align with the collimator, which indirectly ensures the lens collector aligns with the barrel holder.

In addition, to ensure the lens with its center aligning to the barrel and also to other lens to be inserted into the barrel. There may be one ore more than one pushing pairs. Each pushing pair may be made of two collecting part pushed by a spring. The two collecting part clips a lens and their springs with different forces push the lens with different forces. That moves the lens to align with an edge at the end of the lens collector. When all lenses align with the edges of corresponding lens collector, these lenses are aligned to each other and the barrel holder may be adjusted under such condition.

In such design, there may be a plurality of the lens collectors for separately collecting a plurality of lenses to be assembled into the barrel. There is an aligning device having a plurality of pushing pairs. Each pushing pair is corresponding to one lens for pushing the lens to align with the edge of one corresponding lens collector.

The pushing pair may have two springs with different forces for pushing the corresponding lens to one edge of the corresponding lens collector.

In addition, the lens collector may have sucking force for collecting a component different from lens. For example, air driven pump may be used for creating low air pressure to create sucking force to suck and attach the lens.

To control such assembling apparatus, there may be a control device, like a control circuit or a micro computer that runs corresponding software codes. The control device may provide an operator with a plurality of parameter sets with different assembling parameters. For example, an operator who operates the assembling apparatus may be provided with a display for getting input and output of the operator. The operator may select a type of optical component to be inserted to the barrel in an operation, and the control device provides the operator several options to select therefrom. After the operator selects a corresponding option, associated parameters are set consequently, and the operator does not necessary enter all parameters for operating the assembling apparatus. That decreases operating complexity and cost a lot and increases user experience and performance well.

Different parameter sets have different driving forces and driving speeds for driving the barrel holder to move upwardly or downwardly. Such parameters may be further changed by an operator by providing a table to the control device. For example, the operator may edit related parameters with a popular table editor like Excel or Google Tools. Such table may be edited directly on the control device or edited via another machine. The table is sent to the control device and the table is decoded to generate corresponding parameters to control the lens collector and the barrel holder.

In some barrels, the lenses have tilt angle surface and two lenses are contacted at corresponding tilt angle surfaces. The barrel holder is controlled by measuring a plurality of distances when the barrel holder is driven to assemble corresponding lens. The plurality of distances are used as assembling parameter in different stages when assembling a corresponding lens to the barrel.

In summary, the aforementioned embodiments provide an efficient assembling apparatus.

According to anther embodiment of the present invention, an assembling apparatus for assembling a lens barrel to a holder of an electronic device, like a mobile phone with a camera is provided. Such assembling apparatus may be used as a machine in a production pipeline. In this embodiment, the barrel with lens therein is further assembled to a holder, which may have OIS (optical shaking prevention) or simply a holder that further holds an image sensor.

The lens in the barrel are used for directing outside images onto the image sensor via the lens of the barrel. However, when assembling the barrel with lens to the holder, the image sensor is not necessary to be mounted, too. The embodiment may be used for automatically aligning the barrel with lens to the holder.

The assembling apparatus has an illuminated chart for emitting an optical image into lens of the lens barrel with a traversal path. The traversal path is opposite to an image receiving path of the lens barrel for collecting outside image on an image sensor. In other words, the chart is placed at the same side where originally an image sensor is located. The illuminated chart, e.g. with a light source emitting light on a transparent slide with some aligning symbols thereon, is emitting the chart image backwardly via the lens of the barrel to outside. At least one camera for collecting image data corresponding to the optical image is placed at places for capturing the chart image. To make the processing more efficiently, several cameras with low resolution, instead of a high resolution camera, may be used for each collecting a part of the chart image. By analyzing the captured image, unwanted tilt angle between the barrel and the holder may be detected. Such problem may be sent back to a control device of the assembling apparatus to adjust relative assembling position between the lens barrel and the holder. Such operation may be performed for multiple times, which means the cameras are activated again for capturing image data after adjusting the relative assembling position. Then, the control device adjusts the relative assembling position again. Finally, the control device fixes the lens barrel and the holder when the image data matches a predetermined standard.

The lens barrel and the holder may be fixed with glue that is hardened with ultra-violet light. In other cases, the lens barrel may be fixed with corresponding screw structure or other mechanism.

As mentioned above, there may be multiple cameras positioning in different locations for receiving the image data corresponding to different parts of the optical image. The illuminated chart may be a transparent chart illuminated with a light source.

### BRIEF DESCRIPTION OF DRAWINGS

FIG. 1 illustrates a diagram of an assembling apparatus.

FIG. 2A and FIG. 2B illustrate a lens barrel with two different view angles.

FIG. 3 illustrates two lenses with corresponding directing angles.

FIG. 4 illustrates another embodiment of an assembling apparatus.

### DETAILED DESCRIPTION

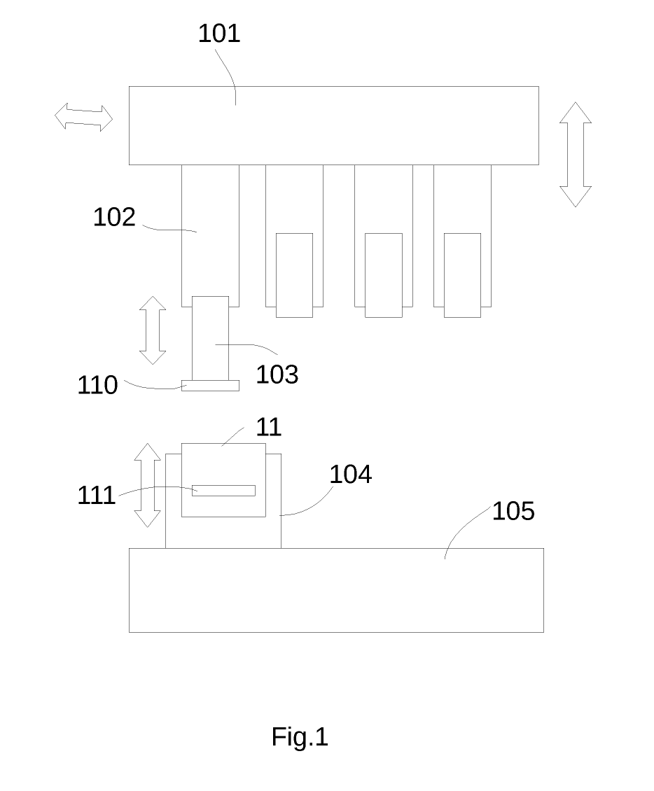

Please refer to FIG. 1. FIG. 1 illustrates a diagram of an assembling apparatus. The assembling apparatus has multiple lens collectors 102. These lens collectors 102 are fixed on a X-Y-Z-axle robot arm 101 that may be moved in X-Y-Z directions. In other words, the lens collector 102 may be moved to a predetermined position to get corresponding components to be assembled. There is a sucking part 103 at bottom of the lens collector 102. Air pressure pump may be used for creating lower air pressure within the sucking part 103 so that the sucking part 103 may suck a corresponding component like a lens 100.

The assembling apparatus also has a barrel holder 104 located on a platform 105. The barrel holder 104 may be driven by a positioning driver like a servo motor with corresponding linking levers and/or rolling balls that may be operated in high precise operation.

The barrel holder 104 is used for holding a barrel 11 for receiving lens 111 or other components like light shielding ring limiting light only passing through its middle part.

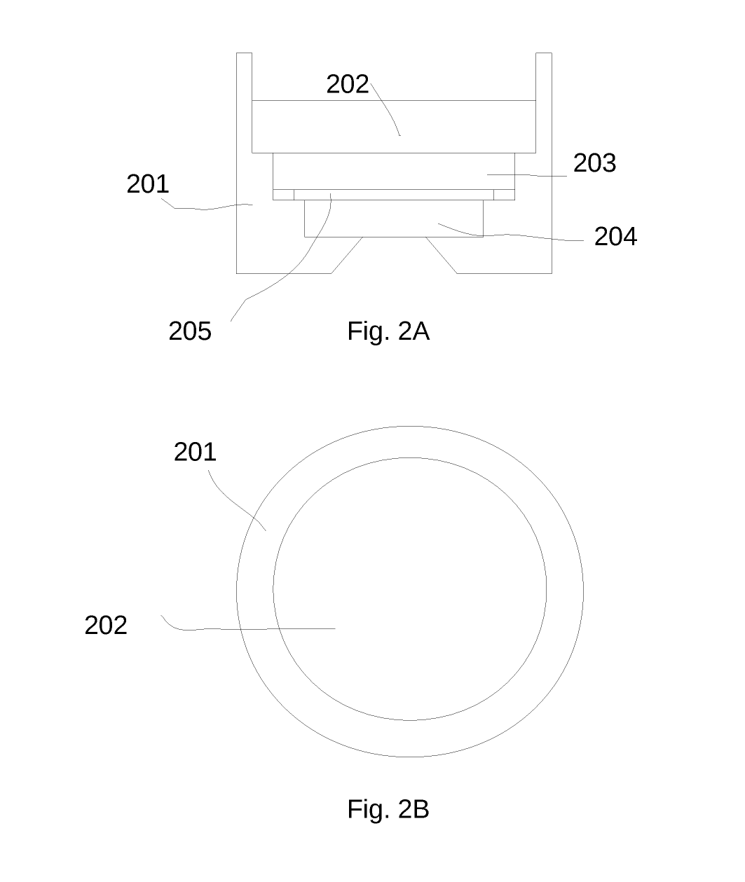

FIG. 2A and FIG. 2B illustrate a barrel 201 with lens or called lens barrel that is used as an optical component of a camera module. Multiple lenses 202, 203, 204 are stacked one after another and some additional component 205 like a SOMA, which allows light to go through its middle opening may be inserted into the barrel 201, too.

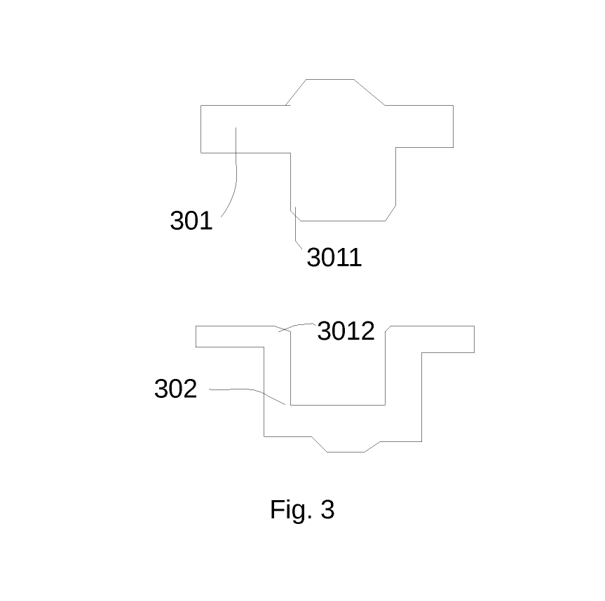

FIG. 3 illustrates two lenses 301, 302 with directing angles 3011 and 3012. During the assembling, the lens 301 is firstly contacting with the bottom lens 32 with smaller force. The directing angles 3011 and 3012 ensure the two lenses 301, 302 to align if not originally so. When such aligning is done, further larger force is applied to place the top lens 301. This method makes the lens to align better.

According to an embodiment of the present invention, an assembling apparatus is designed for assembling an optical module. The optical module includes a barrel holding multiple lenses. To limit unnecessary random light, some light shielding components like SOMA may be put between lenses in a barrel.

The assembling apparatus may include a lens collector and a barrel holder.

The lens collector is designed for getting a lens from a tray plate to be assembled to the barrel. When a barrel needs to mount multiple barrels, there may be multiple lens collectors in one assembling apparatus. Furthermore, there may be two or more sets of such design for assembling two or more barrels in one time.

The lens collector moves the lens above the barrel holder. Then, the barrel holder is designed with a positioning driver for moving the barrel upwardly to engage with the lens with a controlled strength and position driven by the positioning driver.

In some embodiments, when the barrel holder is controlled to move upwardly to engage with the lens, there are an introducing stage and a major assembling stage occurred in sequence. In the introducing stage, a first force is applied to the barrel holder by the positioning driver. In the major assembling stage, a second force is applied to the barrel holder by the positioning driver. The first force is smaller than the second force. For example, in the introducing stage, the force may be 300 g/cm2 and in the major assembling stage, the force may be 2000 g/cm2 to 3000 g/cm2.

To provide precise controlling effect, the positioning driver may include a servo motor with a corresponding driving mechanism, like a series of linkage lever with rolling balls, for driving the barrel holder to move upwardly or downwardly with a controlled speed and force. With optical measuring device, such positioning driver may be controlled within precision level of 0.01 mm.

In some cases when the lens collector is not aligned perfectly with the barrel holder. For example, the surface of the lens held by the lens collector is not parallel to the surface of the barrel. In such case, when the lens is inserted into the barrel, there may be a tilt angle between the lens and the barrel. To make the assembling more reliable as expected, the barrel holder may be moved downwardly for a distance, rotate an angle and then engage the lens again. By changing the barrel with an angle and then applying force thereon, the lens may be assembled more reliably. Such process may be adopted for more than one times. In other words, the barrel holder may be rotated with a plurality of angles for engaging with the barrel with the plurality of angles sequentially. To prevent damage, the barrel holder may be moving downwardly before changing another angle to engage with the lens again.

As mentioned above, there may be a measuring device on the barrel holder to measure the moving distance of the barrel holder. When multiple lenses and other components are stacked one after another into a barrel, each operation may correspond to a measured distance. By calculating multiple measured distances, the relative distance of lens may be obtained. Such result may be fed back to the controlling of the barrel holder. In other words, if there are any unwanted error, such error may be adjusted if available, e.g. by pressing additional force to press the barrel or lens.

In other cases, the lens collector may have an adjusting device for adjusting the relative angle with respect to the barrel holder. For example, several adjusting screws for adjusting angle of the lens collector may be applied. An operator may adjust these adjusting screws to ensure the lens collector aligns better with respect to the barrel holder.

In some cases, a collimator may be used firstly to align with the barrel holder and then the aligned collimator is further used for adjusting the adjusting device of the lens collector for aligning the relative angle between the lenses collector and the barrel holder. Such collimator has a light source to emit light to move within the collimator and the light then moves to a corresponding optical component, e.g. a mirror, before being directed to a sensor. If the collimator is perfectly parallel to the barrel holder that is placed with the optical component, the sensor receives the transmitted light. Otherwise, the collimator is adjusted for an angle until the collimator aligns with the barrel holder. After the collimator aligns with the barrel holder, the lens collector is adjusted to align with the collimator, which indirectly ensures the lens collector aligns with the barrel holder.

In addition, to ensure the lens with its center aligning to the barrel and also to other lens to be inserted into the barrel. There may be one ore more than one pushing pairs. Each pushing pair may be made of two collecting part pushed by a spring. The two collecting part clips a lens and their springs with different forces push the lens with different forces. That moves the lens to align with an edge at the end of the lens collector. When all lenses align with the edges of corresponding lens collector, these lenses are aligned to each other and the barrel holder may be adjusted under such condition.

In such design, there may be a plurality of the lens collectors for separately collecting a plurality of lenses to be assembled into the barrel. There is an aligning device having a plurality of pushing pairs. Each pushing pair is corresponding to one lens for pushing the lens to align with the edge of one corresponding lens collector.

The pushing pair may have two springs with different forces for pushing the corresponding lens to one edge of the corresponding lens collector.

In addition, the lens collector may have sucking force for collecting a component different from lens. For example, air driven pump may be used for creating low air pressure to create sucking force to suck and attach the lens.

To control such assembling apparatus, there may be a control device, like a control circuit or a micro computer that runs corresponding software codes. The control device may provide an operator with a plurality of parameter sets with different assembling parameters. For example, an operator who operates the assembling apparatus may be provided with a display for getting input and output of the operator. The operator may select a type of optical component to be inserted to the barrel in an operation, and the control device provides the operator several options to select therefrom. After the operator selects a corresponding option, associated parameters are set consequently, and the operator does not necessary enter all parameters for operating the assembling apparatus. That decreases operating complexity and cost a lot and increases user experience and performance well.

Different parameter sets have different driving forces and driving speeds for driving the barrel holder to move upwardly or downwardly. Such parameters may be further changed by an operator by providing a table to the control device. For example, the operator may edit related parameters with a popular table editor like Excel or Google Tools. Such table may be edited directly on the control device or edited via another machine. The table is sent to the control device and the table is decoded to generate corresponding parameters to control the lens collector and the barrel holder.

In some barrels, the lenses have tilt angle surface and two lenses are contacted at corresponding tilt angle surfaces. The barrel holder is controlled by measuring a plurality of distances when the barrel holder is driven to assemble corresponding lens. The plurality of distances are used as assembling parameter in different stages when assembling a corresponding lens to the barrel.

In summary, the aforementioned embodiments provide an efficient assembling apparatus.

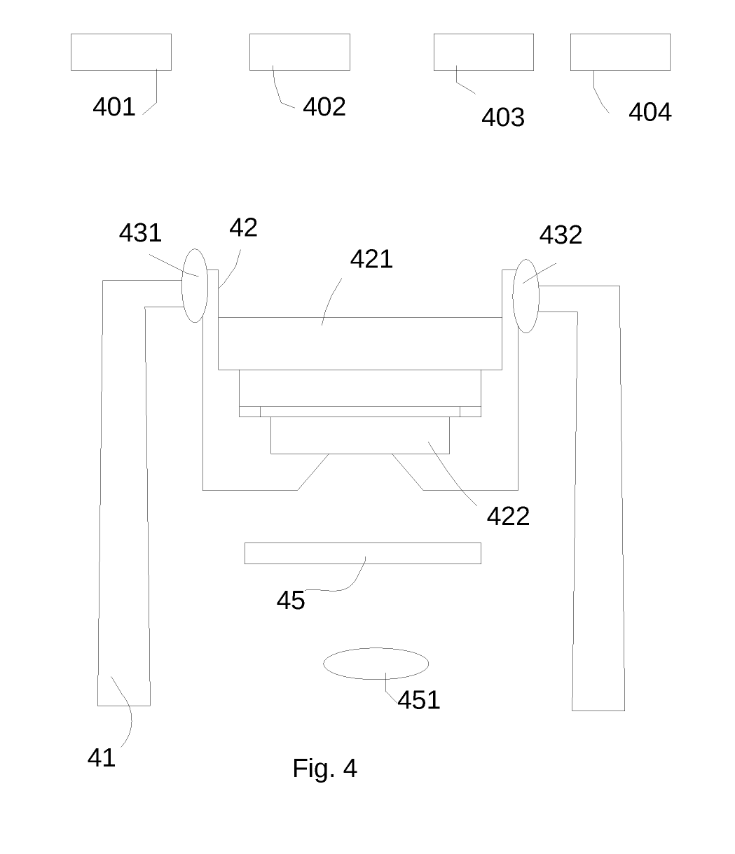

Please refer to FIG. 4, which illustrates another embodiment.

According to anther embodiment of the present invention, an assembling apparatus for assembling a lens barrel 42 to a holder 41 of an electronic device, like a mobile phone with a camera is provided. There may be multiple lenses 421, 422 stacked in the lens barrel 42. Such assembling apparatus may be used as a machine in a production pipeline. In this embodiment, the lens barrel 42 or called barrel with lens therein is further assembled to a holder 41, which may have OIS (optical shaking prevention) or simply a holder 41 that further holds an image sensor.

The lenses 421, 422 in the barrel are used for directing outside images onto the image sensor via the lens of the barrel. However, when assembling the barrel with lens to the holder, the image sensor is not necessary to be mounted, too. The embodiment may be used for automatically aligning the barrel with lens to the holder.

The assembling apparatus has an illuminated chart 45 for emitting an optical image into lens of the lens barrel with a traversal path. The traversal path is opposite to an image receiving path of the lens barrel 42 for collecting outside image on an image sensor. In other words, the illuminated chart 45 is placed at the same side where originally an image sensor is located. The illuminated chart 45, e.g. with a light source 451 emitting light on a transparent slide with some aligning symbols thereon, is emitting the chart image backwardly via the lens of the barrel to outside. At least one camera 401, 402, 403, 404 for collecting image data corresponding to the optical image is placed at places for capturing the chart image. To make the processing more efficiently, several cameras 401, 402, 403, 404 with low resolution, instead of a high resolution camera, may be used for each collecting a part of the chart image. By analyzing the captured image, unwanted tilt angle between the barrel and the holder may be detected. Such problem may be sent back to a control device of the assembling apparatus to adjust relative assembling position between the lens barrel and the holder. Such operation may be performed for multiple times, which means the cameras are activated again for capturing image data after adjusting the relative assembling position. Then, the control device adjusts the relative assembling position again. Finally, the control device fixes the lens barrel and the holder when the image data matches a predetermined standard.

The lens barrel and the holder may be fixed with glue 431, 432 that is hardened with ultra-violet light. In other cases, the lens barrel may be fixed with corresponding screw structure or other mechanism.

As mentioned above, there may be multiple cameras positioning in different locations for receiving the image data corresponding to different parts of the optical image. The illuminated chart may be a transparent chart illuminated with a light source.

Other variations may be adopted but if they use the same inventive spirit, they should also be covered by the present invention as defined by the claims.

In some embodiments, wherein the assembling apparatus for assembling an camera module, the camera module comprising a barrel with multiple lenses, comprise a lens collector for getting multiple lens from a tray plate to be assembled to the barrel, a barrel holder with a positioning driver for installing the multiple lenses to the barrel in series; and a plurality of the lens collectors for separately collecting a plurality of lenses to be assembled into the barrel, and there is a aligning device having a plurality of pushing pairs, each pushing pair is corresponding to one lens for pushing the lens to align with the edge of one corresponding lens collector to ensure the barrel holder to install the multiple lenses accurately.

In some embodiments, wherein the barrel holder has a positioning driver for moving the barrel upwardly to engage with the lens with a controlled strength and position after the lens collector moving the lens above the barrel holder, the positioning driver is controlled to move the barrel holder upwardly and downwardly and to rotate the barrel holder with a controlled angle.

In some embodiments, wherein the assembling apparatus for assembling a lens barrel to a holder of an electronic device comprise an illuminated chart for emitting an optical image into lens of the lens barrel with a traversal path, the traversal path being opposite to an image receiving path of the lens barrel for collecting outside image on an image sensor, at least one camera for collecting image data corresponding to the optical image, and a control device for analyzing the image data and adjust relative assembling position between the lens barrel and the holder, for controlling the camera to capture the image data after adjusting the relative assembling position, for adjusting the relative assembling position again and for fixing the lens barrel and the holder when the image data matching a predetermined standard.

In some embodiments, wherein the lens barrel and the holder are fixed with glue that is hardened with ultra-violet light.

In some embodiments, wherein there are multiple cameras positioning in different locations for receiving the image data corresponding to different parts of the optical image.

In some embodiments, wherein the illuminated chart has a transparent chart illuminated with a light source.

Some embodiments further comprise a lens collector for getting a lens from a tray plate to be assembled to the barrel and a barrel holder with a positioning driver for moving the barrel upwardly to engage with the lens with a controlled strength and position after the lens collector moving the lens above the barrel holder, the positioning driver is controlled to move the barrel holder upwardly and downwardly and to rotate the barrel holder with a controlled angle.

In some embodiments, wherein when the barrel holder is controlled to move upwardly to engage with the lens, there are an introducing stage and a major assembling stage occurred in sequence, in the introducing stage, a first force is applied to the barrel holder by the positioning driver, in the major assembling stage, a second force is applied to the barrel holder by the positioning driver, the first force is smaller than the second force.

In some embodiments, wherein the positioning driver comprises a servo motor with a corresponding driving mechanism for driving the barrel holder to move upwardly or downwardly with a controlled speed and force.

In some embodiments, wherein the barrel holder is rotated with a plurality of angles for engaging with the barrel with the plurality of angles sequentially.

In some embodiments, wherein the barrel holder is moving downwardly before changing another angle to engage with the lens again.

Some embodiments further comprise a measure device for measuring a plurality of distance values when assembling a plurality of corresponding of lens into the barrel, the distance values correspond to relative distance among the plurality of lenses.

In some embodiments, wherein the lens collector has an adjusting device for adjusting the relative angle with respect to the barrel holder.

In some embodiments, wherein a collimator is used firstly to align with the barrel holder and then the aligned collimator is further used for adjusting the adjusting device of the lens collector for aligning the relative angle between the lens collector and the barrel holder.

In some embodiments, wherein there are a plurality of the lens collectors for separately collecting a plurality of lenses to be assembled into the barrel, and there is a aligning device having a plurality of pushing pairs, each pushing pair is corresponding to one lens for pushing the lens to align with the edge of one corresponding lens collector.

In some embodiments, wherein the pushing pair has two springs with different forces for pushing the corresponding lens to one edge of the corresponding lens collector.

In some embodiments, wherein the lens collector has sucking force for collecting a component different from lens.

Some embodiments further comprise a control device, wherein the control device provides an operator with a plurality of parameter sets with different assembling parameters, and different parameter set has different driving forces and driving speeds for driving the barrel holder to move upwardly or downwardly.

In some embodiments, wherein the control device provides the operator an interface for the operator to select a parameter set and adjusts details of the parameter set to control the assembling apparatus.

In some embodiments, wherein the lenses have tilt angle surface and two lenses are contacted at corresponding tilt angle surfaces, the barrel holder is controlled by measuring a plurality of distances when the barrel holder is driven to assemble corresponding lens, and the plurality of distances are used as assembling parameter in different stages when assembling a corresponding lens to the barrel.

1. An assembling apparatus for assembling an optical module, the optical module comprising a barrel holding a plurality of lenses, comprising:
a lens collector for getting a lens from a tray plate to be assembled to the barrel; and
a barrel holder with a positioning driver for moving the barrel upwardly to engage with the lens with a controlled strength and position after the lens collector moving the lens above the barrel holder, the positioning driver is controlled to move the barrel holder upwardly and downwardly and to rotate the barrel holder with a controlled angle.

2. The assembling apparatus of claim 1, wherein when the barrel holder is controlled to move upwardly to engage with the lens, there are an introducing stage and a major assembling stage occurred in sequence, in the introducing stage, a first force is applied to the barrel holder by the positioning driver, in the major assembling stage, a second force is applied to the barrel holder by the positioning driver, the first force is smaller than the second force.

3. The assembling apparatus of claim 1, wherein the positioning driver comprises a servo motor with a corresponding driving mechanism for driving the barrel holder to move upwardly or downwardly with a controlled speed and force.

4. The assembling apparatus of claim 1, wherein the barrel holder is rotated with a plurality of angles for engaging with the barrel with the plurality of angles sequentially.

5. The assembling apparatus of claim 4, wherein the barrel holder is moving downwardly before changing another angle to engage with the lens again.

6. The assembling apparatus of claim 1, further comprising a measure device for measuring a plurality of distance values when assembling a plurality of corresponding of lens into the barrel, the distance values correspond to relative distance among the plurality of lenses.

7. The assembling apparatus of claim 1, wherein the lens collector has an adjusting device for adjusting the relative angle with respect to the barrel holder.

8. The assembling apparatus of claim 1, wherein a collimator is used firstly to align with the barrel holder and then the aligned collimator is further used for adjusting the adjusting device of the lens collector for aligning the relative angle between the lens collector and the barrel holder.

9. The assembling apparatus of claim 1, wherein there are a plurality of the lens collectors for separately collecting a plurality of lens to be assembled into the barrel, and there is a aligning device having a plurality of pushing pairs, each pushing pair is corresponding to one lens for pushing the lens to align with the edge of one corresponding lens collector.

10. The assembling apparatus of claim 9, wherein the pushing pair has two springs with different forces for pushing the corresponding lens to one edge of the corresponding lens collector.

11. The assembling apparatus of claim 1, wherein the lens collector has sucking force for collecting a component different from lens.

12. The assembling apparatus of claim 1, further comprising a control device, wherein the control device provides an operator with a plurality of parameter sets with different assembling parameters, and different parameter set has different driving forces and driving speeds for driving the barrel holder to move upwardly or downwardly.

13. The assembling apparatus of claim 12, wherein the control device provides the operator an interface for the operator to select a parameter set and adjusts details of the parameter set to control the assembling apparatus.

14. The assembling apparatus of claim 1, wherein the lenses have tilt angle surface and two lenses are contacted at corresponding tilt angle surfaces, the barrel holder is controlled by measuring a plurality of distances when the barrel holder is driven to assemble corresponding lens, and the plurality of distances are used as assembling parameter in different stages when assembling a corresponding lens to the barrel.

15. An assembling apparatus for assembling a lens barrel to a holder of an electronic device, comprising:
a illuminated chart for emitting an optical image into lens of the lens barrel with a traversal path, the traversal path being opposite to an image receiving path of the lens barrel for collecting outside image on an image sensor;
at least one camera for collecting image data corresponding to the optical image; and
a control device for analyzing the image data and adjust relative assembling position between the lens barrel and the holder, for controlling the camera to capture the image data after adjusting the relative assembling position, for adjusting the relative assembling position again and for fixing the lens barrel and the holder when the image data matching a predetermined standard.

16. The assembling apparatus of claim 15, wherein the lens barrel and the holder are fixed with glue that is hardened with ultra-violet light.

17. The assembling apparatus of claim 15, wherein there are multiple cameras positioning in different locations for receiving the image data corresponding to different parts of the optical image.

18. The assembling apparatus of claim 15, wherein the illuminated chart has a transparent chart illuminated with a light source.
